(19) United States
(12) Patent Application Publication
(10) Pub. No.: US 2026/0120962 A1
(43) Pub. Date: Apr. 30, 2026

(54) METHOD FOR MANUFACTURING ELECTROLYTIC CAPACITOR

(71) Applicant: Panasonic Intellectual Property Management Co., Ltd., Kadoma-shi, Osaka (JP)

(72) Inventor: Kohei Yamaguchi, SAGA KEN (JP)

(73) Assignee: Panasonic Intellectual Property Management Co., Ltd., Kadoma-shi, Osaka (JP)

(21) Appl. No.: 18/859,271

(22) PCT Filed: Apr. 26, 2023
(86) PCT No.: PCT/JP2023/016461

§ 371 Date: Oct. 23, 2024

(30) Foreign Application Priority Data
Apr. 27, 2022 (JP) 2022-073193

(51) Int. Cl. H01G 9/07; H01G 9/00; H01G 9/042; H01G 9/15

(52) U.S. Cl. CPC H01G 9/07; H01G 9/0032; H01G 9/042; H01G 9/15

(57) ABSTRACT

There is provided a manufacturing method of an electrolytic capacitor including a porous anode body, a dielectric layer formed on a surface of the anode body, and a solid electrolyte layer covering at least a portion of the dielectric layer, the method including a step of forming the dielectric layer by anodizing the anode body, and a step of covering the surface of the anode body on which the dielectric layer is formed, with an insulating polymer. The step of covering with the insulating polymer is a step of impregnating the anode body with a solution containing a monomer that is a raw material of the insulating polymer, applying a voltage between the anode body and an electrode immersed in the solution such that the anode body side is at a lower potential, and polymerizing the monomer on a surface of the dielectric layer to form the insulating polymer.

### TECHNICAL FIELD

The present invention relates to a manufacturing method of an electrolytic capacitor.

### BACKGROUND ART

Electrolytic capacitors are installed in various electronic devices because of their low equivalent series resistance (ESR) and excellent frequency characteristics.

Electrolytic capacitors usually include a capacitor element that has an anode part and a cathode part. The anode part includes a porous anode body, and a dielectric layer is formed on the surface of the anode body. The dielectric layer is in contact with an electrolyte. There are electrolytic capacitors that use a solid electrolyte such as a conductive polymer as the electrolyte (refer to PTL 1 (Japanese Laid-Open Patent Publication No. 2009-182157), for example).

The dielectric layer is usually formed on the surface of a porous anode by anodizing the anode body through chemical conversion treatment. If a defective part exists in the dielectric layer, current that passes through the defective part may flow between the cathode part and the anode part and lead to an increase in leakage current or a decrease in withstand voltage.

PTL 2 (Japanese Laid-Open Patent Publication No. H5-283291) describes a manufacturing method of a solid electrolytic capacitor characterized by sequentially carrying out a step of forming a dielectric oxide film on the surface of an anode metal body having a valve action, a step of forming an insulating polymer film on a defective part of the dielectric oxide film by an electrolytic oxidative polymerization means, a step of forming a chemically polymerized film as a conductive polymer film on the dielectric oxide film and the insulating polymer film, and a step of forming an electrolytically polymerized film as a conductive polymer film on the chemically polymerized film.

### CITATION LIST

### Patent Literatures

PTL 1: Japanese Laid-Open Patent Publication No. 2009-182157

PTL 2: Japanese Laid-Open Patent Publication No. H5-283291

### SUMMARY OF INVENTION

### Technical Problem

PTL 2 proposes improving characteristics such as leakage current by forming an insulating polymer film through oxidative polymerization on a defective part of a dielectric oxide film. However, when forming an insulating polymer film by oxidative polymerization, a voltage of the same polarity as that in the case of forming a dielectric oxide film by anode oxidation is applied, and thus it is necessary to apply a voltage equal to or greater than the voltage used to form the dielectric oxide film. Accordingly, current may also flow to portions of the dielectric layer other than the defective part, and excess dielectric layer may be formed.

### Solution to Problem

In view of this, an aspect of the present disclosure relates to a manufacturing method of an electrolytic capacitor including a porous anode body, a dielectric layer formed on a surface of the anode body, and a solid electrolyte layer covering at least a portion of the dielectric layer, the method including a step of forming the dielectric layer by anodizing the anode body and a step of covering the surface of the anode body on which the dielectric layer is formed, with an insulating polymer, wherein the step of covering with the insulating polymer is a step of impregnating the anode body with a solution containing a monomer that is a raw material of the insulating polymer, applying a voltage between the anode body and an electrode immersed in the solution such that the anode body side is at a lower potential, and polymerizing the monomer on a surface of the dielectric layer to form the insulating polymer.

In view of this, another aspect of the present disclosure relates to an electrolytic capacitor including a porous anode body, a dielectric layer formed on a surface of the anode body and containing an oxide of a metal constituting the anode body, and a solid electrolyte layer covering at least a portion of the dielectric layer, wherein the electrolytic capacitor further includes an insulating polymer layer covering at least a portion of the dielectric layer, and the insulating polymer layer covers a defective portion of the dielectric layer and at least a portion of a surface of the dielectric layer other than the defective portion.

### Advantageous Effects of Invention

The leakage current of an electrolytic capacitor can be reduced.

Novel features of the present invention are set forth in the appended claims, but the present invention, both in terms of structure and content, together with other objects and features of the present invention, will be better understood from the following detailed description taken in conjunction with the drawings.

### BRIEF DESCRIPTION OF DRAWINGS

FIG. 1 A schematic cross-sectional view of an example of a capacitor element of an electrolytic capacitor manufactured by a manufacturing method according to an embodiment of the present disclosure.

FIG. 2 A schematic cross-sectional view of the electrolytic capacitor manufactured by the manufacturing method according to the embodiment of the present disclosure.

FIG. 3 A schematic diagram describing a step of forming an insulating polymer on the surface of an anode body on which a dielectric layer is formed, in the manufacturing method according to the embodiment of the present disclosure.

### DESCRIPTION OF EMBODIMENTS

Hereinafter, embodiments of the present disclosure will be described with examples, but the present disclosure is not limited to the examples described below. In the following description, specific numerical values, materials, and the like will be exemplified, but other numerical values, materials, and the like may be applied as long as the advantageous effects of the present disclosure are obtained. Note that the constituent elements of known secondary batteries may be applied as constituent elements other than characteristic parts of the present disclosure. In the case of the expression “range of numerical value A to numerical value B” herein, the range includes numerical value A and numerical value B, and can be read as “numerical value A or more and numerical value B or less”. In the following description, when lower limits and upper limits of a numerical value related to a specific physical property or condition are exemplified, any of the exemplified lower limits and any of the exemplified upper limits can be combined as desired as long as the lower limit is not greater than or equal to the upper limit. When a plurality of materials are exemplified, one of the materials may be selected and used alone, or two or more of the materials may be used in combination.

The present disclosure also encompasses any combination of matters described in two or more claims selected as desired from the plurality of claims described in the appended claims. That is, matters described in two or more claims selected as desired from the plurality of claims described in the appended claims can be combined as long as no technical contradiction arises.

A manufacturing method of an electrolytic capacitor according to an embodiment of the present disclosure is a manufacturing method of an electrolytic capacitor including a porous anode body, a dielectric layer formed on a surface of the anode body, and a solid electrolyte layer covering at least a portion of the dielectric layer, the method including a step (i) of forming the dielectric layer by anodizing the anode body, and a step (ii) of covering the surface of the anode body on which the dielectric layer is formed, with an insulating polymer.

The step (ii) of covering with an insulating polymer is a step of impregnating the anode body with a solution containing a monomer that is a raw material of the insulating polymer, applying a voltage between the anode body and an electrode immersed in the solution such that the anode body side is at a lower potential, and polymerizing the monomer on a surface of the dielectric layer to form the insulating polymer.

In the manufacturing method of an electrolytic capacitor according to the present embodiment, a voltage opposite in polarity to a voltage for forming the dielectric layer by anodization is applied to the anode body to grow the insulating polymer on the surface of the dielectric layer. That is, a layer of insulating polymer is formed by reductive polymerization.

The anode body is constituted of a valve metal. When a voltage is applied such that the anode body side is at a positive potential and the solution side is at a negative potential so that the anode body is oxidized, current does not easily flow to the anode body constituted of a valve metal. In order to allow current required for polymerization of the insulating polymer to flow in this case, it is necessary to apply a voltage equal to or higher than that applied when forming the dielectric layer (usually, a voltage 2 to 5 times higher than the rated voltage).

On the other hand, when a voltage is applied such that the solution side is at a positive potential and the anode body side is at a negative potential, current easily flows to the anode body constituted of a valve metal. When a voltage is applied such that the anode body side is at a negative potential, a low potential difference of about 0.5 V to 3 V, for example, is applied to enable the current necessary for polymerization of the insulating polymer to flow. Accordingly, a voltage lower than the voltage applied in step (i) of forming the dielectric layer is applied to enable the current necessary for the reductive polymerization of the insulating polymer to flow. Therefore, in step (ii), the insulating polymer can be formed by polymerization so as to reliably cover the defective portion of the dielectric layer, and thus the characteristics of the electrolytic capacitor, such as leakage current, can be improved. In addition, controlling the amount of electricity flowing to the anode body also makes it easy to control the amount of adhesion of the insulating polymer formed by polymerization.

The insulating polymer can be formed so as to cover at least the defective portion of the dielectric layer. However, when the insulating polymer is formed by reductive polymerization, the current flows not only to the defective portion but also to the entire surface of the dielectric layer other than the defective portion. Therefore, the insulating polymer may be formed so as to cover not only the defective portion of the dielectric layer but also the surface of the dielectric layer other than the defective portion. The thickness of the insulating polymer on the surface of the dielectric layer other than the defective portion at this time can be easily controlled by controlling the amount of electricity flowing to the anode body during reductive polymerization. The thickness of the insulating polymer on the surface of the dielectric layer other than the defective portion is 10 nm or less, for example, and may be in the range of 5 nm to 10 nm. The thickness of the insulating polymer is derived by forming a cross section of the anode body perpendicular to the main surface by polishing with an argon beam, and averaging the thicknesses of the insulating polymer at any ten or more points in the cross-sectional image obtained by SEM (FE-SEM is preferable).

The insulating polymer may be any polymer that can be synthesized by reductive polymerization and has sufficient insulating properties. An example of the monomer that is a raw material of the insulating polymer is a vinyl compound.

The vinyl compound includes a compound having a vinyl group (H₂C═CH—). Examples of the vinyl compound include vinylpyridine, acrylic acid, and methacrylic acid, or derivatives thereof. Examples of the derivatives of acrylic acid include esters such as 2-(dimethylamino)ethyl acrylate. Examples of the derivatives of methacrylic acid include esters or amide compounds such as 2-(dimethylamino)ethyl methacrylate and N-(3-dimethylaminopropyl)methacryl amide. Among these, vinylpyridine is preferred because of its high insulating properties and easy availability.

The vinyl compound may be a derivative in which some of the hydrogen atoms of the vinyl group are substituted by an alkyl group or the like. The vinyl compound may be a derivative in which the hydrogen atom at the terminal of the vinyl group is substituted by a nitrile group, such as (CH₃)CH═CHCN. The vinyl compound may be an ester of fumaric acid or maleic acid with an alcohol.

The reductive polymerization is carried out by applying a voltage between the anode body, which is used as a cathode, and an electrode (anode electrode) immersed in the solution, in a state where the anode body is impregnated with a solution containing a monomer that is a raw material of the insulating polymer. The solution contains a supporting salt (electrolyte) in addition to the monomer.

The anode body contains a metal having a valve action, such as titanium, tantalum, niobium, or aluminum. The anode body preferably contains at least one of tantalum and niobium, since these metals are stable even under conditions in which a negative potential is applied for synthesis of the insulating polymer by reductive polymerization. On the other hand, if the anode body is made of aluminum, the aluminum oxide constituting the dielectric layer is likely to dissolve when a negative potential is applied. However, even in this case, it is possible to achieve an electrolytic capacitor in which defective portions of the dielectric layer are covered with the insulating polymer, by forming a thick aluminum oxide film constituting the dielectric layer in advance or by adjusting the thickness of the insulating polymer formed by reductive polymerization.

An electrolytic capacitor according to an embodiment of the present disclosure includes a porous anode body, a dielectric layer formed on the surface of the anode body and containing an oxide of a metal constituting the anode body, and a solid electrolyte layer covering at least a portion of the dielectric layer. The electrolytic capacitor further includes an insulating polymer layer covering at least a portion of the dielectric layer, and the insulating polymer layer covers defective portions of the dielectric layer and at least a portion of the surface of the dielectric layer other than the defective portions.

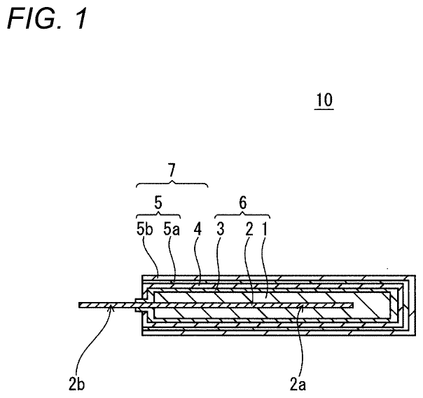

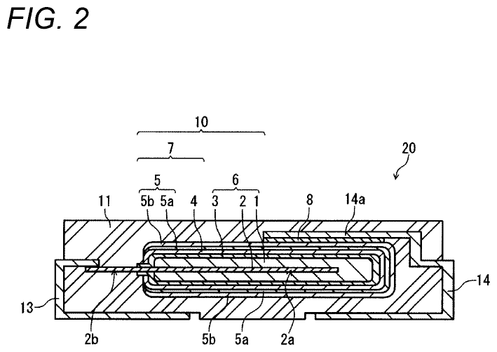

The electrolytic capacitor and the manufacturing method of the electrolytic capacitor according to the present embodiment will be described below with reference to the drawings as appropriate. However, the present invention is not limited to these embodiments. FIG. 1 is a schematic cross-sectional view of an example of a capacitor element of the electrolytic capacitor manufactured by the manufacturing method according to the present embodiment. FIG. 2 is a schematic cross-sectional view of the electrolytic capacitor manufactured by the manufacturing method according to the present embodiment.

An electrolytic capacitor 20 includes a capacitor element 10 that has an anode part 6 and a cathode part 7, an exterior body 11 that seals the capacitor element 10, an anode lead terminal 13 that is electrically connected to the anode part 6 and is partially exposed from the exterior body 11, and a cathode lead terminal 14 that is electrically connected to the cathode part 7 and is partially exposed from the exterior body 11. The anode part 6 has an anode body 1 and an anode wire 2. A dielectric layer 3 is formed on the surface of the anode body. The cathode part 7 has a solid electrolyte layer 4 that covers at least a portion of the dielectric layer 3, and a cathode layer 5 that covers at least a portion of the surface of the solid electrolyte layer 4.

### <Capacitor Element>

The capacitor element 10 will be described in detail below, taking as an example the case where a solid electrolyte layer is provided as an electrolyte.

The anode part 6 has the anode body 1 and the anode wire 2 that extends from one surface of the anode body 1 and is electrically connected to the anode lead terminal 13.

The anode body 1 is a porous sintered body of a rectangular parallelepiped shape obtained by sintering metal particles, for example. As the metal particles, particles of a valve metal such as titanium (Ti), tantalum (Ta), or niobium (Nb) are used. One or more kinds of metal particles are used in the anode body 1. The metal particles may be particles of an alloy of two or more kinds of metals. For example, an alloy containing a valve metal and silicon, vanadium, boron, or the like may be used. A compound containing a valve metal and a typical element such as nitrogen may be used. The valve metal alloy has a valve metal as the main component and contains, for example, 50 atomic % or more of the valve metal.

The anode wire 2 is constituted of a conductive material. The material of the anode wire 2 is not particularly limited, examples of which include the above-described valve metals, copper, aluminum, aluminum alloys, and the like. The materials constituting the anode body 1 and the anode wire 2 may be the same or different. The anode wire 2 has a first part 2a that is embedded in the anode body 1 from one surface of the anode body 1, and a second part 2b that extends from the one surface of the anode body 1. The cross-sectional shape of the anode wire 2 is not particularly limited, examples of which include a circle, a track shape (shape formed of parallel straight lines and two curved lines connecting the ends of the straight lines), an ellipse, a rectangle, a polygon, and the like.

The anode part 6 is fabricated by pressurizing and molding the first part 2a into a rectangular parallelepiped shape with the first part 2a embedded in a powder of particles of the first metal, and then sintering the molded body, for example. Accordingly, the second part 2b of the anode wire 2 is lead out so as to extend from one surface of the anode body 1. The second part 2b is joined to the anode lead terminal 13 by welding or the like, so that the anode wire 2 and the anode lead terminal 13 are electrically connected. The welding method is not particularly limited, examples of which include resistance welding, laser welding, and the like.

The dielectric layer 3 is formed on the surface of the anode body 1. The dielectric layer 3 is constituted of a metal oxide, for example. Examples of methods for forming a layer containing a metal oxide on the surface of the anode body 1 include a method by which the surface of the anode body 1 is anodized by immersing the anode body 1 in a chemical conversion solution, and a method by which the anode body 1 is heated in an atmosphere containing oxygen. The dielectric layer 3 is not limited to the layer containing a metal oxide described above and may be any layer having insulating properties. The thickness of the dielectric layer 3 is in the range of 15 nm to 350 nm, for example.

### (Cathode Part)

The cathode part 7 has a solid electrolyte layer 4 and a cathode layer 5 that covers the solid electrolyte layer 4. The solid electrolyte layer 4 is formed so as to cover at least a portion of the dielectric layer 3.

For example, a manganese compound or a conductive polymer is used for the solid electrolyte layer 4. Examples of the conductive polymer include polypyrrole, polythiophene, polyfuran, polyaniline, polyacetylene, and the like. These may be used alone or in combination. The conductive polymer may be a copolymer of two or more monomers. In terms of excellent conductivity, polythiophene, polyaniline, or polypyrrole may be used. In particular, in terms of excellent water repellency, polypyrrole may be used.

The solid electrolyte layer 4 containing the conductive polymer may be constituted of two or more solid electrolyte layers. The solid electrolyte layer 4 may include two layers, for example, a first conductive polymer layer covering the dielectric layer 3 and a second conductive polymer layer covering the first conductive polymer layer. When the solid electrolyte layer 4 is constituted of two or more layers, the composition and forming method (polymerization method) of the conductive polymer used may be different between the layers. For example, the first conductive polymer layer may be formed by polymerizing a raw material monomer on the dielectric layer 3. Alternatively, the second conductive polymer layer may be formed by applying a liquid containing the conductive polymer to the dielectric layer 3.

Polypyrrole, polythiophene, polyfuran, polyaniline, and the like herein refer to polymers having polypyrrole, polythiophene, polyfuran, polyaniline, and the like as their respective basic skeletons. Therefore, polypyrrole, polythiophene, polyfuran, polyaniline, and the like may also include respective derivatives thereof. For example, polythiophene includes poly(3,4-ethylenedioxythiophene) and the like.

Various dopants may be added to the polymerization liquid for forming the conductive polymer, the solution or dispersion liquid of the conductive polymer in order to improve the conductivity of the conductive polymer. The dopant is not particularly limited, examples of which include naphthalenesulfonic acid, p-toluenesulfonic acid, and polystyrenesulfonic acid.

When the conductive polymer is dispersed in the dispersion medium in a particle state, an average particle diameter D50 of the particles is 0.01 μm or more and 0.5 μm or less, for example. If the average particle diameter D50 of the particles is in this range, the particles can easily penetrate into the anode body 1.

The cathode layer 5 has a carbon layer 5a that is formed so as to cover the solid electrolyte layer 4, and a metal paste layer 5b that is formed on the surface of the carbon layer 5a, for example. The carbon layer 5a contains a conductive carbon material such as graphite, and a resin. The metal paste layer 5b contains metal particles (for example, silver) and a resin, for example. The configuration of the cathode layer 5 is not limited thereto. The configuration of the cathode layer 5 may be any configuration that has a current collecting function.

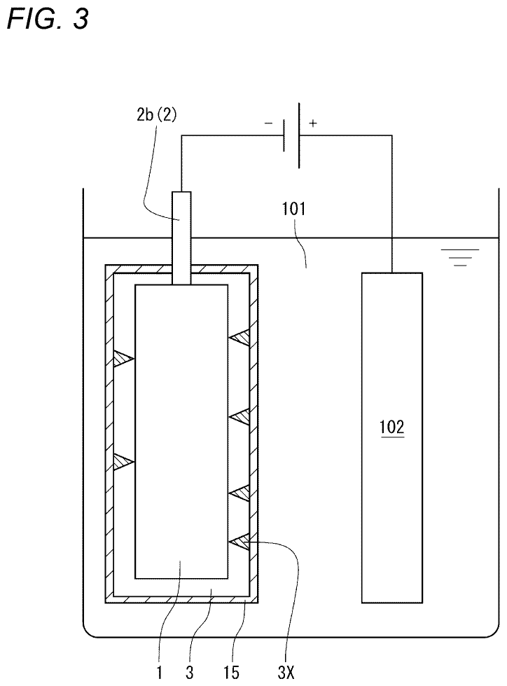

Although not shown in FIGS. 1 and 2, at least a portion of the surface of the dielectric layer 3 may be covered with an insulating polymer layer. The solid electrolyte layer 4 covers the dielectric layer 3 via the insulating polymer at the portion of the surface of the dielectric layer where the insulating polymer layer is formed. The insulating polymer may be formed so as to cover at least defective portions of the dielectric layer 3 (see FIG. 3).

### <Anode Lead Terminal>

The anode lead terminal 13 is electrically connected to the anode body 1 via the second part 2b of the anode wire 2. The material of the anode lead terminal 13 is not particularly limited as long as it is electrochemically and chemically stable and electrically conductive. The anode lead terminal 13 may be made of a metal such as copper, or a nonmetal. The shape of the anode lead terminal 13 is not particularly limited as long as it is a flat plate shape. From the viewpoint of lowering the profile, the thickness of the anode lead terminal 13 (distance between the main surfaces of the anode lead terminal 13) may be 25 μm or more and 200 μm or less, or may be 25 μm or more and 100 μm or less.

One end of the anode lead terminal 13 may be joined to the anode wire 2 with a conductive adhesive or solder, or may be joined to the anode wire 2 by resistance welding or laser welding. The other end of the anode lead terminal 13 is led out to the outside of the exterior body 11 and exposed from the exterior body 11. The conductive adhesive is a mixture of a thermosetting resin described later and carbon particles or metal particles, for example.

### <Cathode Lead Terminal>

The cathode lead terminal 14 is electrically connected to the cathode part 7 at a joint part 14a. The joint part 14a is a part of the cathode lead terminal 14 that overlaps the cathode layer 5, when the cathode layer 5 and the cathode lead terminal 14 joined to the cathode layer 5 are viewed from the normal direction of the cathode layer 5.

The cathode lead terminal 14 is joined to the cathode layer 5 via a conductive adhesive 8, for example. One end of the cathode lead terminal 14 constitutes a portion of the joint part 14a, for example, and is arranged inside the exterior body 11. The other end of the cathode lead terminal 14 is led outside. Therefore, a part of the cathode lead terminal 14 including the other end is exposed from the exterior body 11.

The material of the cathode lead terminal 14 is not particularly limited as long as it is electrochemically and chemically stable and electrically conductive. The cathode lead terminal 14 may be made of a metal such as copper, or a nonmetal. The cathode lead terminal 14 is not particularly limited in shape, and may have an elongated, flat plate shape, for example. From the viewpoint of lowering the profile, the thickness of the cathode lead terminal 14 may be 25 μm or more and 200 μm or less, or may be 25 μm or more and 100 μm or less.

### <Exterior Body>

The exterior body 11 is provided to electrically insulate the anode lead terminal 13 and the cathode lead terminal 14, and is constituted of an insulating material (exterior body material). The exterior body material includes a thermosetting resin, for example. Examples of the thermosetting resin include epoxy resin, phenol resin, silicone resin, melamine resin, urea resin, alkyd resin, polyurethane, polyimide, unsaturated polyester, and the like.

### <<Manufacturing Method of Electrolytic Capacitor>>

Hereinafter, an example of a manufacturing method of the electrolytic capacitor according to the present embodiment will be described.

### (1) Step of Preparing Capacitor Element

First, a capacitor element is prepared. The step of preparing the capacitor element includes a step of preparing an anode body, a step of covering at least a portion of the anode body with a dielectric layer, a step of covering at least a portion of the dielectric layer with a solid electrolyte layer, and a step of covering at least a portion of the solid electrolyte layer with a carbon layer, for example. The step of preparing the capacitor element further includes a step of covering the surface of the anode body on which the dielectric layer is formed, with an insulating polymer. The step of covering at least a portion of the dielectric layer with the solid electrolyte layer is performed after the step of covering with the insulating polymer. In the region on the surface of the dielectric layer that is covered with the insulating polymer, the solid electrolyte layer is formed so as to cover the surface of the dielectric layer with the insulating polymer layer in between.

### (1a) Step of Preparing Anode Body

A porous sintered body can be used as the anode body 1. Valve metal particles and the anode wire 2 are placed in a mold so that the first part 2a is embedded in the valve metal particles, and then pressure-molded and sintered to obtain the anode part 6 including the anode body 1 that is a porous body of the valve metal. The first part 2a of the anode wire is embedded into the porous sintered body from one side. The pressure applied during pressure molding is not particularly limited. The sintering is preferably performed under reduced pressure. The valve metal particles may be mixed with a binder such as polyacrylcarbonate, if necessary.

The valve metal particles are usually pressure-molded using a mold having a rectangular parallelepiped internal space, and then sintered. In this case, the shape of the anode body 1 after sintering is also a rectangular parallelepiped and has a plurality of main surfaces.

### (1b) Step of Forming Dielectric Layer

Next, the anode body 1 is subjected to chemical conversion treatment so that at least a portion of the anode body 1 is covered with the dielectric layer 3. Specifically, the anode body 1 is immersed in an aqueous electrolytic solution (for example, an aqueous phosphoric acid solution) that fills a chemical conversion tank, the second part 2b of the anode wire 2 is connected to the anode electrode in the chemical conversion tank to perform anodization, thereby forming the dielectric layer 3 made of an oxide film of the valve metal on the surface of the porous part. The aqueous electrolytic solution is not limited to an aqueous phosphoric acid solution, and nitric acid, acetic acid, sulfuric acid, and the like can be used.

### (1c) Step of Forming Insulating Polymer

Next, the surface of the anode body on which the dielectric layer is formed is covered with an insulating polymer. Specifically, the anode body 1 and an external electrode are placed in an electrolysis tank filled with a reaction solution containing a monomer of an insulating polymer, the anode body 1 and the external electrode are immersed in the reaction solution, and a voltage is applied between the anode body 1 and the external electrode so that the anode body 1 is at a lower potential than the external electrode, for example. FIG. 3 is a schematic diagram showing the state of the anode body 1 immersed in a reaction solution 101 at this time. An external electrode 102 is an anode, and by applying a voltage such that the anode body 1 side becomes a cathode, a reductive polymerization reaction of the monomer progresses on the surface of the dielectric layer 3, and an insulating polymer layer 15 grows so as to cover the dielectric layer 3.

In the chemical conversion treatment of the anode body 1, defective portions 3X may form in the dielectric layer 3. The insulating polymer is formed so as to cover defective portions of the dielectric layer 3. The insulating polymer is also formed so as to cover the surface of the dielectric layer 3 other than the defective portions. FIG. 3 shows an example of an insulating polymer layer that covers defective portions and the surface of the dielectric layer 3 other than the defective portions. Note that, in FIG. 3, the entire surface of the dielectric layer 3 other than the defective portions 3X is covered with the insulating polymer layer 15, but there may be a partial area on the surface of the dielectric layer 3 other than the defective portions 3X in which the dielectric layer 3 is not covered with the insulating polymer layer 15 and is exposed.

The monomer subjected to reductive polymerization is not particularly limited as long as an insulating polymer layer 15 having sufficient insulating properties can be formed by reductive polymerization, but a vinyl compound such as vinylpyridine is preferable, for example. Therefore, the insulating polymer layer 15 preferably contains an insulating polymer having a vinyl compound as a monomer unit.

The insulating polymer layer 15 has a thickness of 5 nm to 10 nm, for example, which is sufficiently thinner than the dielectric layer 3.

The solution (reaction solution) in which the anode body 1 and the external electrode 102 are immersed contains a monomer, a solvent in which the monomer dissolves or disperses, and a supporting salt (electrolyte) for imparting electrical conductivity to the solution. Examples of the supporting salt include sulfate and ammonium perchlorate. The solvent may be water or a non-aqueous solvent such as dimethylformamide, dimethylsulfoxide, tetrahydrofuran, acetonitrile, ethylene glycol dimethyl ether, or ethylene glycol diethyl ether.

### (1d) Step of Forming Solid Electrolyte Layer

Next, at least a portion of the dielectric layer 3 is covered with the solid electrolyte layer 4 with the insulating polymer layer in between. This results in the capacitor element 10 including the anode body 1, the dielectric layer 3, and the solid electrolyte layer 4. The solid electrolyte layer 4 may include a plurality of conductive polymer layers.

The solid electrolyte layer 4 may be formed of a plurality of layers. For example, the solid electrolyte layer 4 may include two layers, namely, a first conductive polymer layer that is formed on the dielectric layer side and a second conductive polymer layer that is formed on the first conductive polymer layer on the side opposite to the dielectric layer. The first conductive polymer layer may be formed by chemical polymerization or electrolytic polymerization, and the second conductive polymer layer may be formed on the first conductive polymer layer by applying a dispersion liquid containing the second conductive polymer and then drying the applied dispersion liquid.

The step of forming the solid electrolyte layer may include, for example, a step of impregnating the anode body with a solution containing a first monomer that is a raw material of the first conductive polymer, and polymerizing the monomer on the surface of the dielectric layer or the insulating layer to form the first conductive polymer layer covering the dielectric layer, and a step of impregnating the anode body with a second dispersion liquid containing a second conductive polymer, and forming the second conductive polymer layer covering the first conductive polymer layer.

In the step of forming the first conductive polymer layer, the anode body 1 is impregnated with a monomer or oligomer, and then the monomer or oligomer is polymerized by chemical polymerization or electrolytic polymerization to form the first conductive polymer layer on the anode body 1 on which the dielectric layer 3 is formed.

In this case, the raw material monomer of the first conductive polymer is subjected to oxidative polymerization (so-called “in situ polymerization”) upward of the dielectric layer 3 to form the first conductive polymer layer on the dielectric layer 3 (or the insulating polymer layer). Therefore, fine asperities may occur on the surface of the first conductive polymer layer due to non-uniform polymerization reaction, non-uniform layer growth, or the like.

Next, in the step of forming the second conductive polymer layer, the anode body 1 on which the first conductive polymer layer is formed is immersed in a second dispersion liquid containing a pre-polymerized second conductive polymer, and then is taken out and dried. Accordingly, the second conductive polymer layer is formed on at least the surface of a portion of the first conductive polymer layer. The dispersion liquid may contain a binder and/or conductive inorganic particles (for example, a conductive carbon material such as carbon black). A known binder can be used for the binder. The dispersion liquid may contain a known additive used in forming a solid electrolyte layer.

At least a part of the step of forming the second conductive polymer layer may be performed in a decompressed state. Decompression treatment is desirably performed before the step of drying the anode body impregnated with the second dispersion liquid.

This improves the adhesion between the first conductive polymer layer and the second conductive polymer layer.

For example, the anode body may be immersed in the second dispersion liquid, and after the anode body is pulled out of the solution or dispersion liquid, decompression treatment may be performed on the anode body with the second dispersion liquid adhering thereto, or the anode body may be placed in a decompressed state and then impregnated with the second dispersion liquid in a decompressed state. The decompression removes air from the gaps between the recesses in the surface of the first conductive polymer layer and the second conductive polymer layer, so that the second conductive polymer layer with fluidity can easily enter the recesses in the first conductive polymer layer, thereby improving the adhesion between the first conductive polymer layer and the second conductive polymer layer.

The first conductive polymer and the second conductive polymer may contain a dopant. The conductive polymer and the dopant may be selected from those exemplified for the solid electrolyte layer 4.

### (1e) Step of Forming Carbon Layer and Conductive Resin Layer

Next, a carbon paste and a metal paste are applied in sequence to the surface of the solid electrolyte layer 4, thereby forming the cathode layer 5 that is constituted of the carbon layer 5a and the metal paste layer 5b. The configuration of the cathode layer 5 is not limited thereto and may be any configuration having a current collecting function.

### (2) Step of Electrically Connecting Capacitor Element and Lead Terminal

Next, the anode lead terminal 13 and the cathode lead terminal 14 are prepared. The second part 2b of the anode wire 2 extending from the anode body 1 is joined to the anode lead terminal 13 by laser welding, resistance welding, or the like. In addition, after applying the conductive adhesive 8 to the cathode layer 5, the cathode lead terminal 14 is joined to the cathode part 7 via the conductive adhesive 8.

Next, the capacitor element 10 and the material of the exterior body 11 (for example, an uncured thermosetting resin and a filler) are placed in a mold, and the capacitor element 10 is sealed by transfer molding, compression molding, or the like. At this time, the anode lead terminal 13 and the cathode lead terminal 14 are partially exposed from the mold. The molding conditions are not particularly limited, and time and temperature conditions may be set as appropriate taking into consideration the curing temperature of the thermosetting resin used, and the like.

Finally, the exposed portions of the anode lead terminal 13 and the cathode lead terminal 14 are bent along the exterior body 11 to form bent portions. Accordingly, the portions of the anode lead terminal 13 and the cathode lead terminal 14 are arranged on an installation surface of the exterior body 11.

By the above method, the electrolytic capacitor 20 is manufactured.

### (Supplementary Notes)

The above description of the embodiments discloses the following techniques.

### (Technique 1)

A manufacturing method of an electrolytic capacitor including a porous anode body, a dielectric layer formed on a surface of the anode body, and a solid electrolyte layer covering at least a portion of the dielectric layer, the method including:
a step of forming the dielectric layer by anodizing the anode body; and
a step of covering the surface of the anode body on which the dielectric layer is formed, with an insulating polymer,
wherein the step of covering with the insulating polymer is a step of impregnating the anode body with a solution containing a monomer that is a raw material of the insulating polymer, applying a voltage between the anode body and an electrode immersed in the solution such that the anode body side is at a lower potential, and polymerizing the monomer on a surface of the dielectric layer to form the insulating polymer.

### (Technique 2)

The manufacturing method of an electrolytic capacitor according to Technique 1, wherein the insulating polymer is formed so as to cover a defective portion of the dielectric layer and to cover a surface of the dielectric layer other than the defective portion.

### (Technique 3)

The manufacturing method of an electrolytic capacitor according to Technique 1 or 2, wherein the monomer includes a vinyl compound.

### (Technique 4)

The manufacturing method of an electrolytic capacitor according to any one of Techniques 1 to 3, wherein the anode body contains at least one of tantalum and niobium.

### (Technique 5)

An electrolytic capacitor including a porous anode body, a dielectric layer formed on a surface of the anode body and containing an oxide of a metal constituting the anode body, and a solid electrolyte layer covering at least a portion of the dielectric layer,
wherein the electrolytic capacitor further includes an insulating polymer layer covering at least a portion of the dielectric layer, and
the insulating polymer layer covers a defective portion of the dielectric layer and at least a portion of a surface of the dielectric layer other than the defective portion.

### (Technique 6)

The electrolytic capacitor according to Technique 5, wherein the insulating polymer layer contains a polymer having a vinyl compound as a monomer unit.

### (Technique 7)

The electrolytic capacitor according to Technique 5 or 6, wherein the anode body contains at least one of tantalum and niobium.

### INDUSTRIAL APPLICABILITY

The present invention can be used in electrolytic capacitors, and preferably in electrolytic capacitors that use a porous body as an anode body.

Although the present invention has been described with respect to the presently preferred embodiments, such disclosure should not be interpreted as limiting. Various variations and modifications will no doubt become apparent to those skilled in the art to which the present invention pertains upon reading the above disclosure. Accordingly, the appended claims should be interpreted to cover all changes and modifications without departing from the true spirit and scope of the present invention.

### REFERENCE SIGNS LIST

20: electrolytic capacitor, 10: capacitor element, 1: anode body, 2: anode wire, 2a: first part, 2b: second part, 3: dielectric layer, 3x: defective portion, 4: solid electrolyte layer, 5: cathode layer, 5a: carbon layer, 5b: metal paste layer, 6: anode part, 7: cathode part, 8: conductive adhesive, 11: exterior body, 13: anode lead terminal, 14: cathode lead terminal, 14a: joint part, 15: insulating polymer layer, 100: battery case, 101: reaction solution, 102: external electrode (anode) Application No. Not Yet Assigned

1. A manufacturing method of an electrolytic capacitor including a porous anode body, a dielectric layer formed on a surface of the anode body, and a solid electrolyte layer covering at least a portion of the dielectric layer, the method comprising:
a step of forming the dielectric layer by anodizing the anode body; and
a step of covering the surface of the anode body on which the dielectric layer is formed, with an insulating polymer, wherein the step of covering with the insulating polymer is a step of impregnating the anode body with a solution containing a monomer that is a raw material of the insulating polymer, applying a voltage between the anode body and an electrode immersed in the solution such that the anode body side is at a lower potential, and polymerizing the monomer on a surface of the dielectric layer to form the insulating polymer.

2. The manufacturing method of an electrolytic capacitor according to claim 1, wherein the insulating polymer is formed so as to cover a defective portion of the dielectric layer and to cover a surface of the dielectric layer other than the defective portion.

3. The manufacturing method of an electrolytic capacitor according to claim 1, wherein the monomer includes a vinyl compound.

4. The manufacturing method of an electrolytic capacitor according to claim 1, wherein the anode body contains at least one of tantalum and niobium.

5. An electrolytic capacitor including a porous anode body, a dielectric layer formed on a surface of the anode body and containing an oxide of a metal constituting the anode body, and a solid electrolyte layer covering at least a portion of the dielectric layer,
wherein the electrolytic capacitor further includes an insulating polymer layer covering at least a portion of the dielectric layer, and
the insulating polymer layer covers a defective portion of the dielectric layer and at least a portion of a surface of the dielectric layer other than the defective portion.

6. The electrolytic capacitor according to claim 5, wherein the insulating polymer layer contains a polymer having a vinyl compound as a monomer unit.

7. The electrolytic capacitor according to claim wherein the anode body contains at least one of tantalum and niobium.
